(19) United States
(12) Patent Application Publication
(10) Pub. No.: US 2001/0019965 A1
(43) Pub. Date: Sep. 6, 2001

(54) Game system and method for network player credit-wagering

(76) Inventor: Yasushi Ochi, Osaka (JP)

Correspondence Address: SHINJYU GLOBAL IP COUNSELORS, LLP, 1233 20TH STREET, NW, SUITE 700, WASHINGTON, DC, 20036-2680, US

(21) Appl. No.: 09/796,423

(22) Filed: Mar. 2, 2001

(30) Foreign Application Priority Data
Mar. 6, 2000 (JP) 2000-061260
Apr. 6, 2000 (JP) 2000-104518

(51) Int. Cl. G06F 17/00

(52) U.S. Cl. 463/25; 463/42

(57) ABSTRACT

Game system for maintaining enthusiasm for and excitement of match-type games performed over a network. A central administrating device, game terminal devices 30, terminal management devices 31, and entry-processing devices 39 are connected over a network. Game execution credits are assigned by investing a certain amount of money into the entry-processing device 39. When a players and spectator wagerer accesses a terminal management device, the central administrating device performs a game entry procedure, and subtracts game execution credits from the players and spectator wagerer's credits. Players and spectator wagerers can bet their credits against one another. The credits put at stake that are added/subtracted depending on the game result are specified via the terminal management device 31, and players and spectator wagerer's credits are updated in accordance with the game result.

### BACKGROUND OF THE INVENTION

1. Technical Field

The present invention relates to game systems comprising a plurality of game terminal devices interconnected via communications media, whereby using the game terminal devices multiple players can compete against one another in match-type games.

2. Description of Related Art

As is evident from JP H11-33230A or JP H11-319319A, in the past numerous game systems have been proposed in which a network is formed by interconnecting a plurality of game terminal devices so that a plurality of players can compete in match-type games against one another via the game terminal devices.

The game terminal devices in these game systems are all made for playing various kinds of computer games. If the match-type game is a game that players play solitarily, the players conduct the game vying for dominance by competing among themselves for points gained. If the game itself pits the players against each other in a match-as in the Japanese game of go (on which the board game Othello™ is partly based)-the winner is determined in the game.

However, instances in the above-described match-type game systems of games that players play solitarily mean that the players conduct the games with the computer as rival. When the game is repeated any number of times, the player's skill at the game will increase, but counter to which a certain routine will set in such that the thrill is lost, spoiling interest in the game.

On the other hand, if the game itself takes the form of a match, as in the game of go, then the thrill of the game can be maintained by switching opponents, which keeps play from, as just described, getting into a rut. But if the ability levels of the adversaries are mutually too different, interest in the match itself is then spoiled.

### SUMMARY OF THE INVENTION

Given the foregoing situation, an object of the present invention is to achieve a game system for both games of form in which matches are performed by players solitarily, as well as those of form in which the game itself is the match, that maintains enthusiasm toward the games, and is highly stimulating to continually keep up the players' interest.

In order to achieve these objects, in a game system according to a first aspect of the present invention: a central administrating device is connected over a communication medium to terminal management devices linked to corresponding game terminal devices, and a plurality of players can play a game over these game terminal devices; the game system includes an entry-processing device, connected over the communication medium to the central administrating device, for collecting identification information of players, which it sends to the central administrating device, and for collecting payments from the outside, sending collected payment information to the central administrating device; the terminal management devices collect the identification information of players and send it to the central administrating device, and enable execution of a game on a game terminal device after receiving a signal indicating that game execution is possible from the central administrating device; the central administrating device issues a credit count in accordance with the payment information received from the entry-processing device, which is taken as the credit count of that player and stored in association with the player identification information also received from the entry-processing device; if player identification information is received from the terminal management device and that player's credit count meets the predetermined credit count necessary for the execution of the game on the game terminal, then the central administrating device subtracts game execution credits from that player's credits, the player's credit count is updated with the calculated credit count, and the signal indicating that game execution is possible is sent to the terminal management device; and players can bet their credits against one another, and the credits put at stake that are added/subtracted to/from a player's credits depending on the game result are determined via the terminal management device, the credits at stake are added/subtracted to/from a player's credits in accordance with the game result, and the player's credits are updated with the calculated credit count.

In accordance with this aspect of the invention, the. player's identification information and payment information is sent from the entry-processing device to the central administrating device when a player enters personal identification information and invests a discretionary amount of money into the entry-processing device, the central administrating device issues a credit count depending on the received payment information, the issued credit count is taken as the credit count the player holds, which is stored in association with the player's identification information.

Thus, after at least personal identification information has been registered in the central administrating device, a player can execute a game using a game terminal device by carrying out the following process: First, the player inputs personal identification information into the terminal management device. When the player's identification information has been input, the terminal management device sends it to the central administrating device, which checks whether the credit count of the registered player meets a predetermined credit count necessary to execute a game on that game terminal device. If the necessary credit count is met, the game execution credits are subtracted from the player's credit count, the registered player's credit count is updated with the calculated credit count, and a signal indicating that game execution is possible is sent to the terminal management device. Then, when this signal indicating that game execution is possible has been received by the terminal management device, game execution on that game terminal device is enabled by the terminal management device.

Then, if the player wishes to participate in a match and bet a credit count, the match content is specified via the terminal management device under control of the central administrating device, and the player can execute the specified match-type game. Depending on the outcome of the game, the registered players' credits are updated in the central administrating device.

Thus, in accordance with this aspect of the present invention, when a plurality of players compete in a game, they can bet their own game execution credits. The players therefore can enjoy the game in an environment in which the result (that is, the outcome) of the game is linked to the player's advantage or disadvantage by increasing or decreasing the player's game execution credits. Thus the game can be played while fresh enthusiasm is always kept up. Consequently, this solves the problem of the prior art, that by repeating the same game a number of times, a certain routine will set in, wearing down the interest in the game.

According to a second aspect of the present invention, in a game system as in the first aspect, the entry-processing device is connected over the communication medium to the central administrating device. The entry-processing device collects identification information on players and sends the information to the central administrating device; collects payments from outside, issues credits in accordance with the collected payments, and sends the issued credits to the central administrating device. The central administrating device takes the credit count received from the entry-processing device as the credit count of that player and stores it in association with the player identification information also received from the entry-processing device. If player identification information is received from the terminal management device and that player's credit count meets the predetermined credit count necessary for the execution of the game on the game terminal, then the central administrating device subtracts game execution credits from that player's credits, the player's credit count is updated with the calculated credit count, and the signal indicating that game execution is possible is sent to the terminal management device. Thus players can bet their credits against one another, and the credits put at stake that are added/subtracted to/from a player's credits depending on the game result are determined by the central administrating device via the terminal management device, the credits at stake are added/subtracted to/from a player's credits in accordance with the game result, and the player's credits are updated with the calculated credit count.

In accordance with this aspect of the invention, when a player enters personal identification information and invests a discretionary amount of money into the entry-processing device, the player is issued a credit count depending on the invested money, the player's identification information and issued credits are sent from the entry-processing device to the central administrating device and stored in the central administrating device. Then, the player inputs personal identification information into the terminal management device, which is sent to the central administrating device, and if the credit count of the registered player meets a predetermined credit count necessary to execute a game on that game terminal, then the central administrating device subtracts the game execution credits from the player's credit count, the registered player's credit count is updated with the calculated credit count, a signal indicating that game execution is possible is sent to the terminal management device, and game execution on that game terminal device is enabled by the terminal management device. Then, if the player wishes to participate in a match and bet a credit count, the match content is specified via the terminal management device under control of the central administrating device, and the player can execute the specified match-type game. Depending on the outcome of the game, the registered players' credits are updated in the central administrating device.

Thus, in accordance with this aspect of the present invention, as in the first aspect of the present invention, when a plurality of players compete in a game, they can bet their own game execution credits. The players therefore can enjoy the game in an environment in which the result (that is, the outcome) of the game is linked to the player's advantage or disadvantage by increasing or decreasing the player's game execution credits. Thus the game can be played while fresh enthusiasm is always kept up. Consequently, this solves the problem of the prior art, that by repeating the same game a number of times, a certain routine will set in, wearing down the interest in the game.

According to a third aspect of the present invention, in a game system as in the second aspect, the entry-processing device collects identification information of players and sends it to the central administrating device, and receives credits of players from the central administrating device. If the credit count meets the predetermined credit count necessary for the execution of the game on the-game terminal, then game execution credits are subtracted from that player's credits, the calculated credit count is sent to the central administrating device, and game execution with the game terminal device is enabled. Herein the central administrating device takes the credit count received from the entry-processing device as the credit count of that player and stores it in association with the player identification information also received from the entry-processing device. After receiving player identification information from the terminal management device, the central administrating device sends that player's credit count to the terminal management device, and after receiving the calculated credit count from the terminal management device, it updates the credit count of that player. Thus players can bet their credits against one another, and the credits put at stake that are added/subtracted to/from a player's credits depending on the game result are determined by the central administrating device via the terminal management device, the credits at stake are added/subtracted to/from a player's credits in accordance with the game result, and the player's credits are updated with the calculated credit count.

In accordance with this aspect of the invention, when a player enters personal identification information and invests a discretionary amount of money into the entry-processing device the player is issued a credit count depending on the invested money, the player's identification information and issued credits are sent from the entry-processing device to the central administrating device and stored in the central administrating device. Then, when the player inputs personal identification information into the terminal management device, the terminal management device sends this personal identification information to the central administrating device, receives the player's credit count from the central administrating device, and if the received credit count meets the predetermined credit count necessary to execute a game on that game terminal, then the game execution credits are subtracted from the player's credit count, the calculated credit count is sent to the central administrating device, and game execution on that game terminal device is enabled. When the central administrating device has received the calculated credit count from the terminal management device, it updates that player's registered credit count with the received credit count. If the player wishes to participate in a match and bet a credit count, the match content is specified via the terminal management device. Then, the player can execute the specified match-type game. Depending on the outcome of the game, the registered players' credits are updated in the central administrating device.

Thus, in accordance with this aspect of the present invention, as in the first and second aspect of the present invention, when a plurality of players compete in a game, they can bet their own game execution credits. The players therefore can enjoy the game in an environment in which the result (that is, the outcome) of the game is linked to the player's advantage or disadvantage by increasing or decreasing the player's game execution credits. Thus the game can be played while fresh enthusiasm is always kept up. Consequently, this solves the problem of the prior art, that by repeating the same game a number of times, a certain routine will set in, wearing down the interest in the game.

In a game system according to a fourth aspect of the present invention, a central administrating device is connected over a communication medium to terminal management devices linked to corresponding game terminal devices, and a plurality of players can play a game over these game terminal devices. The game system includes: a portable storage medium for storing credits that can be used to execute a game; and an entry-processing device, connected over the communication medium to the central administrating device, which can be connected to the portable storage medium, collects payment from the outside, and stores on the portable storage medium a credit count issued in accordance with the payment. The terminal management device performs a game execution entry process when connected to the portable storage medium, subtracts a predetermined credit count necessary for executing the game from the credit count stored on the portable storage medium, updates the credit count stored on the portable storage medium with the calculated credit count, and enables execution of the game on the game terminal device. Thus players can bet their credits against one another, and the central administrating device determines via the terminal management devices the credit count put at stake that are added/subtracted to/from the credits stored on the player's portable storage medium depending on the game result, adds/subtracts the credits at stake to/from the player's credits in accordance with the game result, and updates the credits stored on the player's portable storage medium with the calculated credit count via the terminal management device.

According to this aspect of the present invention, a player first obtains a portable storage medium on which at least the credit count needed to execute a game is stored. After this portable storage medium is connected to the entry-processing device, the player invests a discretionary amount of money into the entry-processing device, whereby a corresponding credit count is written onto the portable storage medium. Then, to execute the game, the player connects the portable storage medium to a terminal management device. When it is connected to the portable storage medium, the terminal management device performs a game execution entry process, a predetermined credit count necessary for executing the game is subtracted from the credit count stored on the portable storage medium, the credit count stored on the portable storage medium is updated with this calculated credit count, and game execution on that game terminal device is enabled.

Thus, when the entry process on the terminal management device is terminated, players can bet their credits against one another, and the central administrating device determines via the terminal management devices the credit count put at stake that are added/subtracted to/from the credits stored on the player's portable storage medium depending on the game result. That is, through a process performed by the central administrating device, the player specifies one or more players to compete with via the game system, as well as the credit count at stake that are exchanged depending on the outcome of the game.

Thus, when the credit count put at stake has been determined, the players play the game on their game terminal devices. When the game is terminated, the central administrating device receives the game result from the terminal management devices, determines victory and defeat of the players, adds/subtracts the staked credits to/from the players' credits in accordance with the game result, and updates the credits stored on the players' portable storage medium with the calculated credit count via the terminal management devices.

Thus, in accordance with this aspect of the present invention, as in the first to third aspect of the present invention, when a plurality of players compete in a game, they can bet their own game execution credits. The players therefore can enjoy the game in an environment in which the result (that is, the outcome) of the game is linked to the player's advantage or disadvantage by increasing or decreasing the player's game execution credits. Thus the game can be played while fresh enthusiasm is always kept up. Consequently, this solves the problem of the prior art, that by repeating the same game a number of times, a certain routine will set in, wearing down the interest in the game.

In a modification of the fourth aspect of the present invention, a central administrating device is connected over a communication medium to terminal management devices linked to corresponding game terminal devices, and a plurality of players can play a game over these game terminal devices; wherein the game system includes: a portable storage medium for storing credits that can be used to execute a game; and a credit issuing device connected to the central administrating device, which can be connected to the portable storage medium, collects payment from the outside, and stores on the portable storage medium a credit count issued in accordance with the payment. When the terminal management device is connected to the portable storage medium, a game execution entry process is carried out, a predetermined credit count necessary for executing the game is subtracted from the credit count stored on the portable storage medium, the credit count stored on the portable storage medium is updated with the calculated credit count, and execution of the game on the game terminal device is enabled. Herein players can bet their credits against one another, and the central administrating device determines via the terminal management devices the credit count put at stake that are added/subtracted to/from the credits stored on the player's portable storage medium depending on the game result, adds/subtracts the credits at stake to/from the player's credits in accordance with the game result, and updates the credits stored on the player's portable storage medium with the calculated credit count via the terminal management device.

According to this aspect of the present invention, a player first obtains a portable storage medium on which at least the credit count needed to execute a game is stored. After this portable storage medium is connected to the credit issuing device, the player inserts a discretionary amount of money into the credit issuing device, whereby a corresponding credit count is written onto the portable storage medium. Then, to execute the game, the player connects the portable storage medium to a terminal management device. When it is connected to the portable storage medium, the terminal management device performs a game execution entry process, a predetermined credit count necessary for executing the game is subtracted from the credit count stored on the portable storage medium, the credit count stored on the portable storage medium is updated with this calculated credit count, and game execution on that game terminal device is enabled.

Thus, when the entry process on the terminal management device is terminated, players can bet their credits against one another, and the central administrating device determines via the terminal management devices the credit count put at stake that are added/subtracted to/from the credits stored on the player's portable storage medium depending on the game result. That is to say, through a process performed by the central administrating device, the player specifies one or more players to compete with via the game system, as well as the credit count at stake that are exchanged depending on the outcome of the game.

Thus, when the credit count put at stake has been determined, the players play the game on their game terminal devices. When the game is terminated, the central administrating device receives the game result from the terminal management devices, determines victory and defeat of the players, adds/subtracts the credits at stake to/from the players' credits in accordance with the game result, and updates the credits stored on the players' portable storage medium with the calculated credit count via the terminal management devices.

Thus, in accordance with this aspect of the present invention, when a plurality of players compete in a game, they can bet their own game execution credits, so that the players can participate in the game in an environment in which the result (that is, the outcome) of the game is linked to the player's advantage or disadvantage by increasing or decreasing the player's game execution credits, so that the game can be played while maintaining a continual sense of excitement. Consequently, this solves the problem of the prior art, that by repeating the same game a number of times, a certain routine will set in, wearing down the interest in the game.

According to a fifth aspect of the present invention, in a game system as in the first to fourth aspect, the central administrating device comprises a handicap setting process unit for assigning a handicap in accordance with a player's skills. Herein the outcome of a game is determined in consideration of the assigned handicap.

If the opponents' skill levels are too different, then a player can predict the outcome of the game too easily when betting credits as described above, so that the excitement of the game erodes and interest in the match is lost, but in accordance with this aspect of the present invention, handicaps can be assigned in accordance with the players' skills, and the outcome has to be predicted giving consideration to the handicaps. Therefore the outcome of the game is not so easy to predict after all, so that the players maintain a sense of excitement for the game, and do not loose their interest in matches.

According to a sixth aspect of the present invention, in a game system as in the first to fifth aspect, the credits issued in accordance with the payment collected by the entry-processing device are adjusted in accordance with a currency exchange rate of the country in which the entry-processing device is located.

In a game system in accordance with this aspect of the present invention, the central administrating device and the terminal management devices linked to the game terminal devices are interconnected via a communication medium, so that the game terminal devices and terminal management devices as well as the entry-processing devices may be located in different countries. In that case, if there are unclear standards for setting the number of game execution credits needed to execute game, which is specified by the payment collected by the entry-processing device, then, due to the differences in the currency exchange rates among those countries, the value of game execution credits needed to execute game may differ. Consequently, if in one country the value of one credit is, for example, 10 Japanese Yen and the value of one credit in another country is 100 Japanese Yen, and the credit count of those players is set on par, then the advantage obtained by winning a match is larger for the player in whose country one credit has the higher value, so that a certain inequality among those players occurs. With this aspect of the present invention, however, the credit count issued by the entry-processing device is adjusted in accordance with the currency exchange rate of the country where the entry-processing device is located, which means that the value of one credit is set to be equivalent in all countries, so that when players from different countries compete, the payoffs can be set to be equivalent for all players.

If the credits are issued by the central administrating device, as in the first aspect of the present invention, then this adjustment is possible by storing the currency exchange data in the central administrating device, and if the credits are issued by the entry-processing device, as in the second to fourth aspects of the present invention, then this adjustment is possible by storing the currency exchange data in the central administrating device or in the entry-processing device.

In a game system according to this aspect of the present invention, the central administrating device may comprise an exchange data storage unit for storing currency exchange rate information for the country in which the credit issuing device is located; wherein the credit issuing device receives from the central administrating device currency exchange data relating to the country in which the credit issuing device is located; and the credit count written onto the portable storage medium is adjusted in accordance with the received currency exchange rate data.

According to a seventh aspect of the invention, in a game system as in the foregoing aspects, third party players who are not competing in the game can bet their credits against one another. The central administrating device determines via the terminal management devices the credit count put at stake that are added/subtracted to/from the third party players' credits. The central administrating device further adds/subtracts the credits at stake to/from the third party players' credits (which may be stored on the portable storage medium) in accordance with the game result. Then the central administrating device updates the third party players' credits with the calculated credit count, which it-may do via the terminal management device.

With this aspect of the present invention, third party players who are not the competing players can participate indirectly in the game by betting their credits, so they can enjoy the game from a different angle by trying to predict the outcome of the game and rooting for the player they have placed their bet on.

The game terminal devices in the present invention can be TV game devices displaying the game on a screen, or slot machines, pachinko machines or pinball game machines.

If the game terminal devices are TV game devices, then, according to an eighth aspect of the present invention, the central administrating device stores a game program, and the game program is distributed from the central administrating device to the game terminal devices. Thus, a plurality of different games can be executed on one game terminal device. In this case, if the distributed game programs can constitute a virtual game arcade in the game machine, then the player can participate in games of this virtual game arcade. Thus, the player can play a game under the impression that the game takes place in a game arcade, even though the game machines are located outside a game arcade, for example at the player's home.

According to a ninth aspect of the present invention, a game that can be performed on the game system as in the first to eighth aspect includes educational information. For example, it is possible to take the solving of mathematical problems, a quiz on historical facts or other questions appearing in school tests as the subject of a game, and let the players compete in giving the fastest answer or striving for the highest ratio of correct answers. In this way, such educational information can be gained very effectively, since the object of enticing interest is the players, who are exposed to educational information through the medium of a game by which the information can be grappled with in earnest.

From the following detailed description in conjunction with the accompanying drawings, the foregoing and other objects, features, aspects and advantages of the present invention will become readily apparent to those skilled in the art.

### BRIEF DESCRIPTION OF THE DRAWINGS

FIG. 1 is a diagram showing the general configuration of a game system in accordance with an embodiment of the present invention;

FIG. 2 is a block diagram illustrating the device configuration on the terminal side of the game system in this embodiment;

Fig, 3 is a block diagram showing the configuration of a central administrating device in this embodiment;

FIG. 4 is a flowchart showing the process performed by the central administrating device in this embodiment;

FIG. 5 is a Flowchart showing the process performed by the game entry processing unit in this embodiment;

FIG. 6 is a flowchart showing the process performed by the match content setting process module in this embodiment;

FIG. 7 is a flowchart showing the process performed by the spectator-wagering content setting process module in this embodiment;

FIG. 8 is a flowchart showing the process for reflecting the match results performed by the central administrating device in this embodiment;

FIG. 9 is a flowchart showing the process for reflecting the spectator results performed by the central administrating device in this embodiment;

FIG. 10 is a diagram showing the general configuration of a game system in accordance with another embodiment of the present invention;

FIG. 11 is a block diagram illustrating the device configuration on the side of a terminal of the game system of this other embodiment;

FIG. 12 is a block diagram showing the configuration of the central administrating device in this other embodiment;

FIG. 13 is a flowchart showing the process performed by the central administrating device in this other embodiment;

FIG. 14 is a flowchart showing the process performed by the game entry processing unit in this other embodiment;

FIG. 15 is a flowchart showing the process performed by the match content setting process unit in this other embodiment;

FIG. 16 is a flowchart showing the process performed by the spectator-wagering content setting process module in this other embodiment;

FIG. 17 is a flowchart showing the process for reflecting the match results performed by the central administrating device in this other embodiment; and

FIG. 18 is a flowchart showing the process for reflecting the spectator results performed by the central administrating device in this other embodiment.

### DETAILED DESCRIPTION OF THE PREFERRED EMBODIMENTS

The following is an explanation of specific embodiments of the present invention, with reference to the accompanying drawings.

First Embodiment

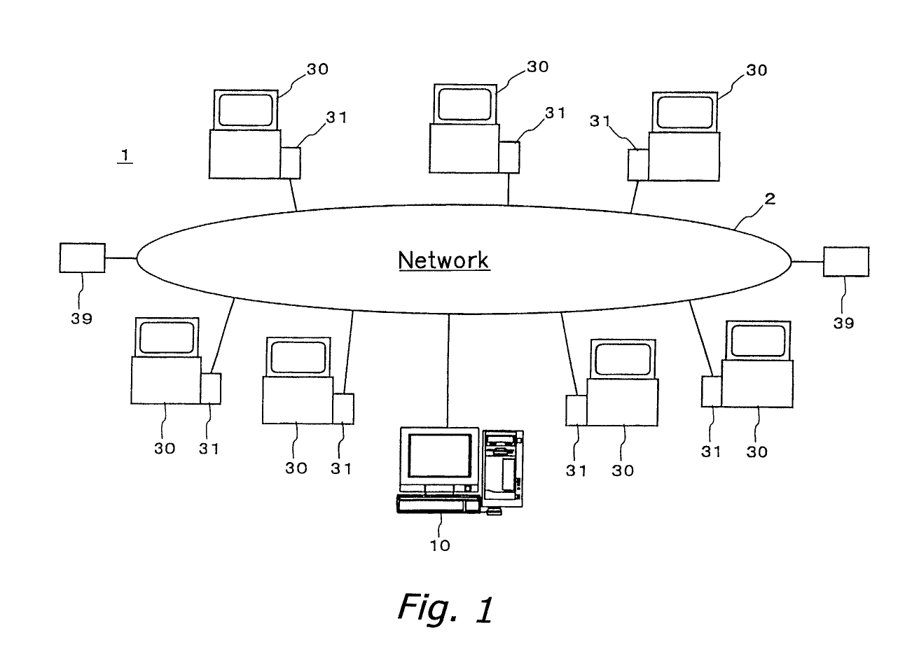

The first embodiment of the present invention is explained with-reference to FIGS. 1 through 9. FIG. 1 illustrates the general configuration of a game system in accordance with this first embodiment.

As shown in FIG. 1, a game system 1 in accordance with this example includes a plurality of game machines (game terminal devices) 30 and terminal management devices 31 linked to the game machines 30, the game machines 30 and terminal management devices 31 being provided at game arcades or at private homes, as well as entry-processing devices 39 and a central administrating device (“central administrator” hereinafter) 10. All these devices are connected by a network 2, such as the Internet. The game machines 30 can be large commercial game machines as installed in game arcades, small game machines for home use, or game devices using a personal computer. The game machines 30 are connected via the terminal management devices 31 to the network 2.

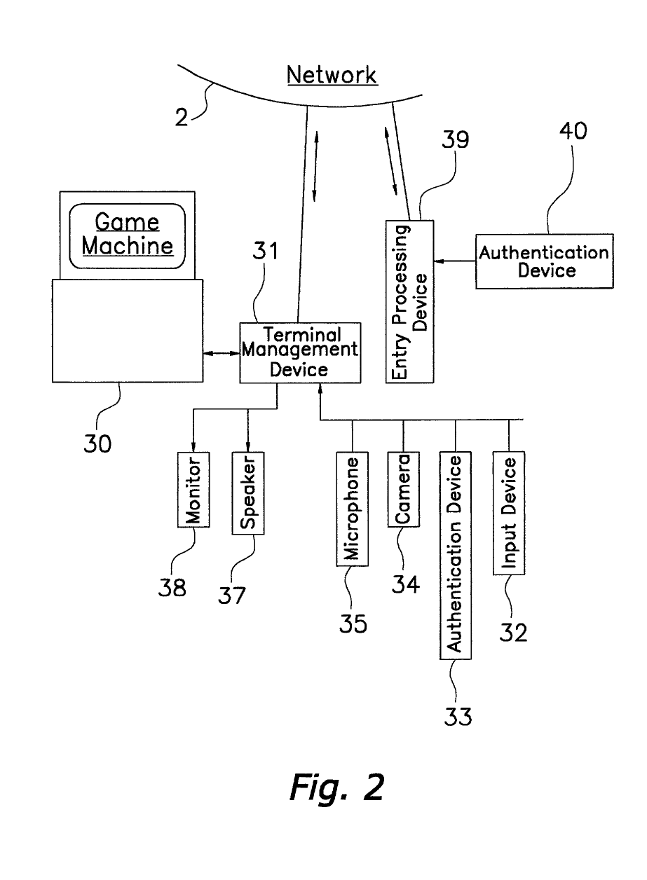

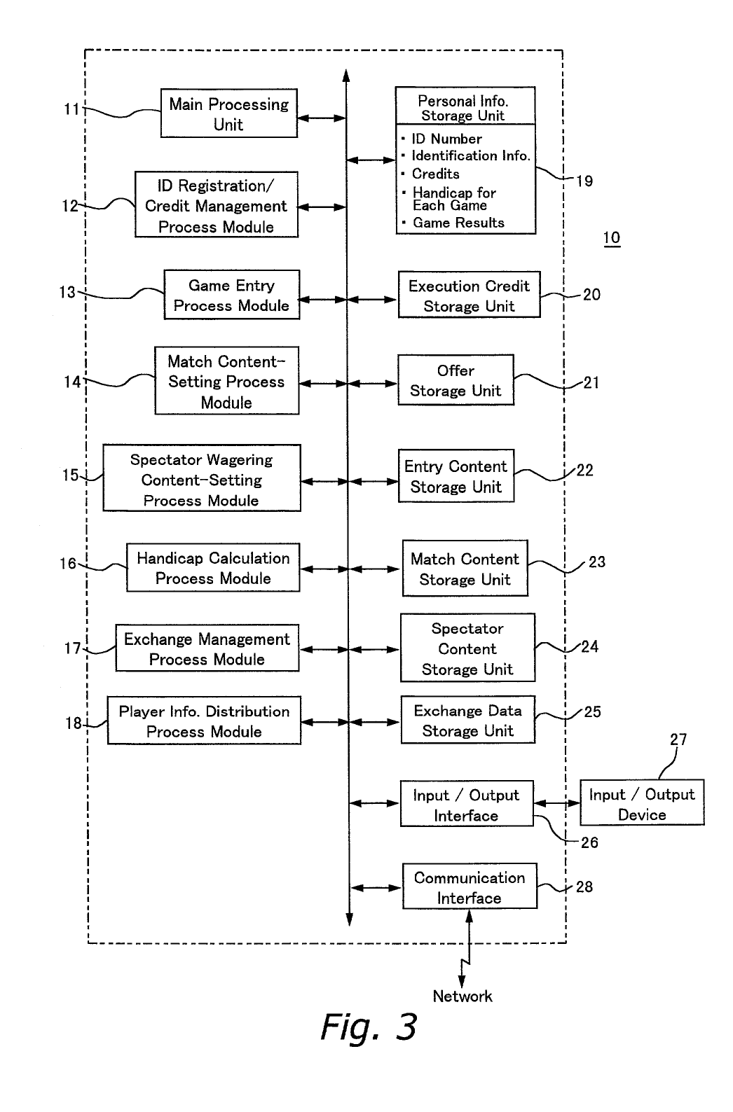

As shown in FIG. 2, a terminal management device 31 is connected to an input device 32, an authentication device 33, a camera 34, a microphone 35, a speaker 37, and a monitor 38. The terminal management device 31 sends data that are input with the input device 32, the authentication device 33, the camera 34, and the microphone 35 to the central administrator 10 and outputs signals that it receives from the central administrator 10 with the speaker 37 and the monitor 38. The camera 34 is arranged to pick up the player's facial expression, and the microphone 35 is arranged to pick up the player's voice.

The entry-processing device 39 includes an authentication device 40, and sends personal identification information associated with the player that has been obtained with this authentication device 40 to the central administrator 10. The entry-processing device 39 also collects money invested by the player, and sends this collected payment information to the central administrator 10. The authentication device 40 has the same function as the aforementioned authentication device 33, and these authentication devices can acquire identification information, such as an image of the player's face, a fingerprint or a voiceprint.

When inputting a game application signal with the input device 32, the terminal management device 31 performs a game execution entry process. That is, the player's identification information that has been obtained by the authentication device 33 is sent to the central administrator 10, and if a signal indicating that game execution is possible is received from the central administrator 10, execution of the game on the game machine 30 is enabled. On the other hand, when a signal indicating that game execution is not possible is received from the central administrator 10, the monitor 38 displays a message to the effect that execution of the game is not possible.

As shown in FIG. 3, the central administrator 10 includes a number of process modules, namely: a main processing unit 11, an ID registration/credit management processing unit 12, a game entry processing unit 13, a match content setting process module 14, a spectator-wagering content setting process module 15, a handicap calculation process module 16, an exchange management process module 17, and a player information distribution process module 18, as well as a personal information storage unit 19, an execution credit storage unit 20, an offer storage unit 21, an entry information storage unit 22, a match content storage unit 23, a spectator (participation) content storage unit 24, an exchange data storage unit 25, an input/output interface 26, and a communication interface 28, all of which are connected over a bus line. An input/output device 27 is connected to the input/output interface 26. The network 2 is connected via the communication interface 28.

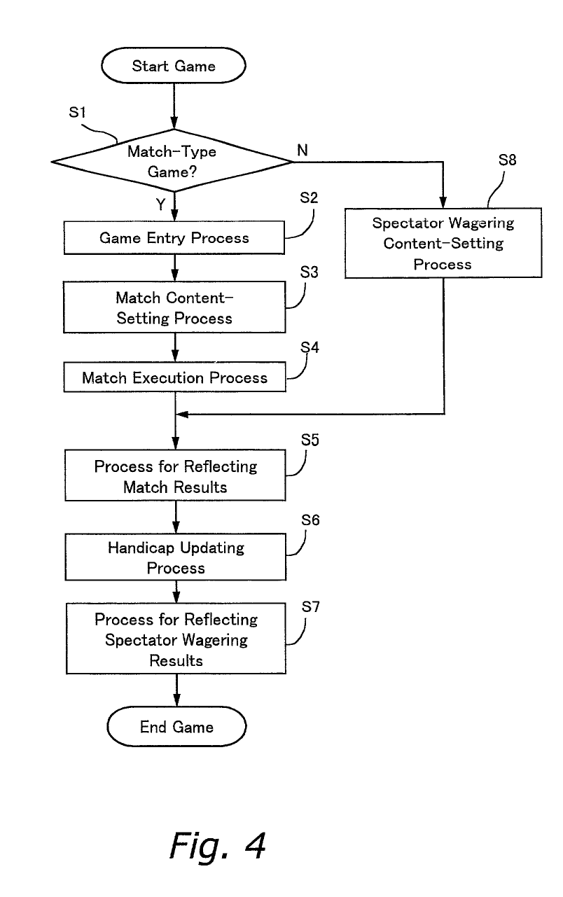

The main processing unit 11 gives process execution commands to the ID registration/credit management processing unit 12, the game entry processing unit 13, the match content setting process module 14, the spectator-wagering content setting process module 15, the handicap calculation process module 16, the exchange management process module 17, and the player information distribution process module 18, and performs the game execution process shown in FIG. 4. The following is a detailed description of these various units.

The exchange management process module 17 stores the currency exchange rates for all relevant countries (which have been input with the input/output device 27 or obtained through the network 2) in the exchange data storage unit 25, and updates the exchange data stored in the exchange data storage unit 25 in periodic or aperiodic intervals.

The function of the personal information storage unit 19 is to store for each player such data as ID number, identification information, credits, as well as handicap, game results and ranking for each game. The ID registration/credit management processing unit 12 receives the identification information and the payment information from the entry-processing device 39, and if the identification information is not yet registered, then the ID registration/credit management processing unit 12 assigns an ID number associated with the identification information, obtains the currency exchange rate for the country where the entry-processing device 39 is located, which is stored in the exchange data storage unit 25, and issues a predetermined credit count in accordance with the received payment and in consideration of the above-mentioned currency exchange rate. To give a specific example for issuing a credit count in consideration of the currency exchange rate, if for example one dollar is equivalent to ten credits, and the present currency exchange rate for Japanese Yen is one US Dollar to 110 Japanese Yen, then ten credits are issued in Japan for each 110 Yen. Similarly, credits are issued in accordance with the currency exchange rate for other countries as well. Then, the identification information, ID number and number of issued credits are stored in the personal information storage unit 19. On the other hand, if the identification information is already registered, then the credit count that has been issued as described above is added to the credit count associated with the identification information stored in the personal information storage unit 19.

The ID registration/credit management processing unit 12 also receives from the terminal management device 31 player identification information when game execution is requested, compares the received identification information with the identification information stored in the personal information storage unit 19, retrieves the credit count of the player registered under this identification information, and if the retrieved credit count meets the credit count necessary for executing a game on the corresponding game machine 30, the game execution credits are subtracted from the retrieved credits, the credit count associated with the identification information stored in the personal information storage unit 19 is updated with the credit count resulting from this calculation, a signal indicating that game execution is possible is sent to the terminal management device 31, and a process-start command is sent to the game entry processing unit 13. If, however, the retrieved credit count does not meet the credit count necessary for executing a game, then a signal indicating that game execution is not possible is sent to the terminal management device 31. The credit count for executing a game on the game machine 30 is stored beforehand in the execution credit storage unit 20.

For each game, the handicap calculation process module 16 retrieves the game result data stored in the personal information storage unit 19, adds up the game results, such as the scores, that a player has achieved over, for example, the last five games, calculates the average score, and subtracts the average score of that player from the average score of the player with the highest average score, to calculate the handicap of that player for that game. Then the calculated handicap for each game is stored in the personal information storage unit 19. If a player has completed less than five games, then that player's handicap is set to a predetermined initial value.

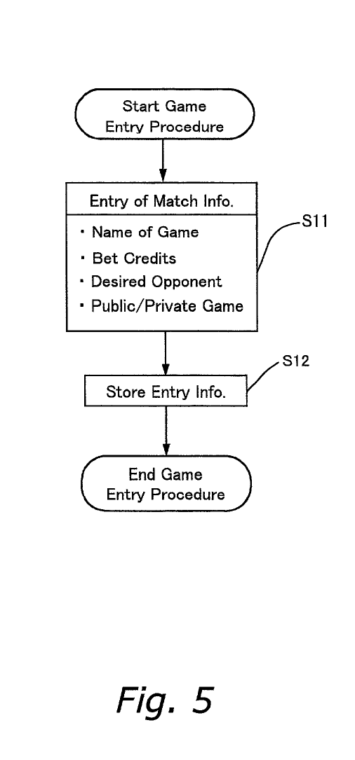

The game entry processing unit 13 performs the game entry process (Step S2) indicated in FIG. 4, following the flowchart shown in FIG. 5. That is, as shown in FIG. 5, the game entry processing unit 13 begins the process after receiving a start-process command from the ID registration/credit management unit 12, and prompts the player through the terminal management device 31 to input such game content as game classifier, credits put at stake, desired opponent, public or private game. The game entry processing unit 13 then accepts the input (Step S11), and stores the accepted game content in the entry content storage unit 22. If the desired opponent is available, it also stores the relevant entry content in the offer storage unit 21 (Step S12), whereafter the process is terminated.

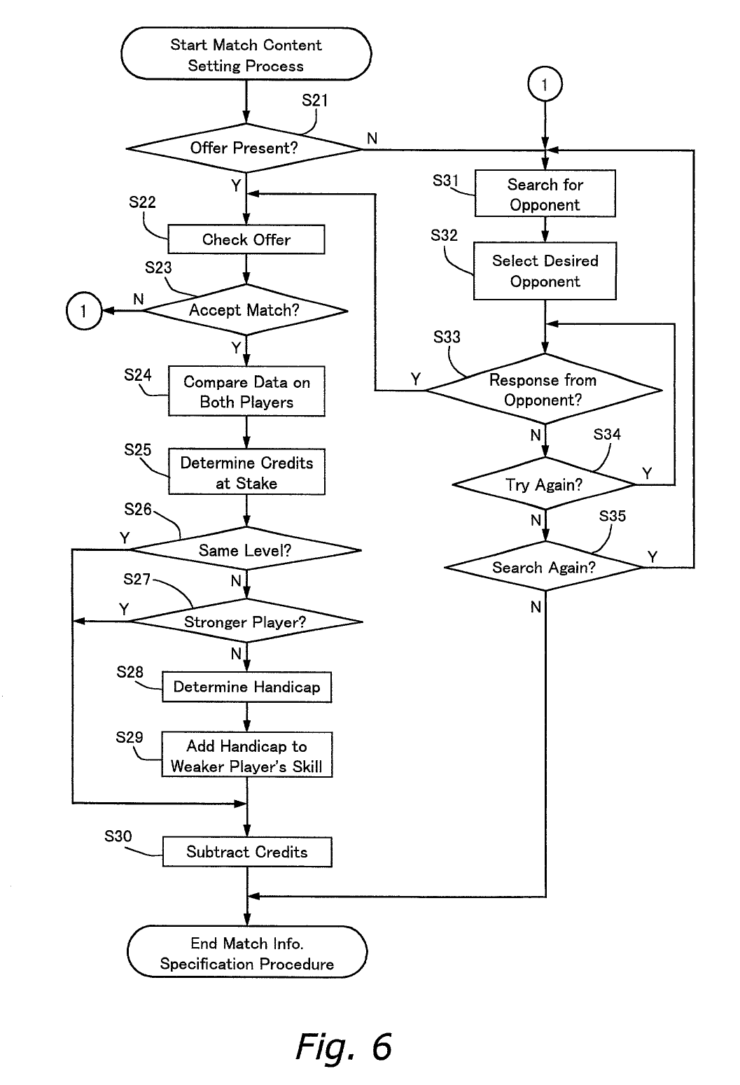

Following the flowchart shown in FIG. 6, the match content setting process module 14 performs the match content setting process indicated in FIG. 4 (Step S3). That is, as shown in FIG. 6, the match content setting process module 14 first searches the entry information stored in the offer storage unit 21 to check whether there is an application for a match against the given player (Step S21). If there is an application, process module 14 sends the corresponding entry content (offer content) to the terminal management device 31 used by the players, where it is displayed on the monitor 38, and confirms whether the given player intends to accept the match (Steps S22 and S23).

Then, if players are willing to enter into the match, the entry content for the two competitors is compared (Step S24), and the bet credit number for the given match is set to the lower of the bet credit numbers (Step S25). Then whether the skill rating (handicap) of the two players is the same is determined (Step S26). If the skill rating of the two players is different, then the difference between the handicaps of both players is taken as the handicap for this game and this calculated handicap is assigned the player with the lower rating (player with the larger handicap) (Steps S27 to S29), and the process is terminated. No handicap is assigned to the player who is determined by Step S27 to have the larger skill level. If, on the other hand, Step S26 determines that the skill rating of the two players is about the same, then no handicap is assigned. After carrying out this handicap assignment process, a process is performed to subtract the number of staked credits from the players' credit count (Step S30). Specifically, an update command is given to the ID registration/credit management processing unit 12, whereby the credit count stored in the personal information storage unit 19 is updated with the credit count resulting from this subtraction.

If Step S21 determines that there is no application for a match, then a list of registered players is sent to the terminal management device 31 used by the player, where it is displayed on the monitor 38, so that the player can search for potential opponents (Step S31), and select a desired opponent (Step S32). If there is a response from the selected opponent, then the process jumps to Step S22 (Step S33). If there is no response from the selected opponent, then whether the player intends to try again is checked (Step S34). If the player does not intend to try again, whether the player intends to search for another opponent is checked (Step S35). If the player intends to search for another opponent, then the process jumps to Step S31, and if the player does not intend to search for another opponent, then the process is terminated. If at Step S23 either one of the players does not accept the match, then the process jumps to Step S31. Then the match content specified in this manner is stored in the match content storage unit 23.

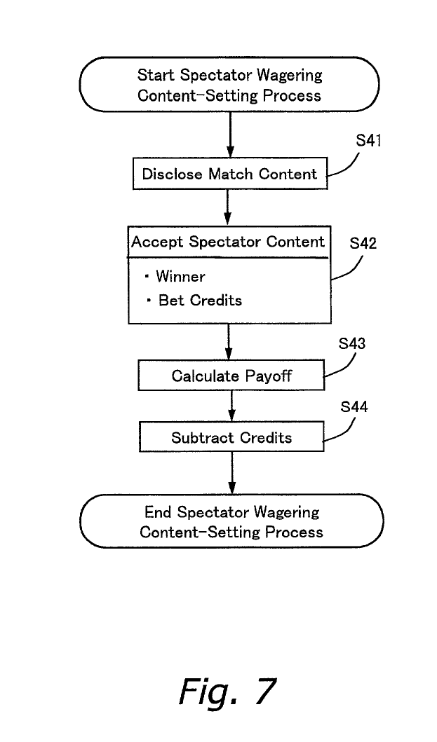

Following the flowchart shown in FIG. 7, the spectator-wagering content setting process module 15 performs the spectator-wagering game content-setting process indicated in FIG. 4 (Step S8). That is, in response to a request from a terminal management device 31 used by a third party (who is not one of the competing players; “spectator” hereinafter), the spectator-wagering content setting process module 15 first sends the match content on the set-up game to the terminal management device 31, and discloses the match content to this spectator (Step S41), as shown in FIG. 7. Then, spectator participation content is collected from the spectators' terminal management devices 31 (Step S42). The spectator participation content that is collected from the spectators' terminal management devices 31 is which one of the players a spectator predicts will win, and how many credits the spectator bets on the victory of this player. After the payoff for the wager has been calculated (Step S43), the afore-mentioned credit count put at stake is subtracted from the spectator's credit count (Step S44). More specifically, an update command is given to the ID registration/credit management processing unit 12, whereby the spectator's credit count stored in the personal information storage unit 19 is updated with the credit count resulting from this subtraction. Then, the process is terminated. The spectator game (third-party wagering) information configured in this manner is stored in the spectator content storage unit 24.

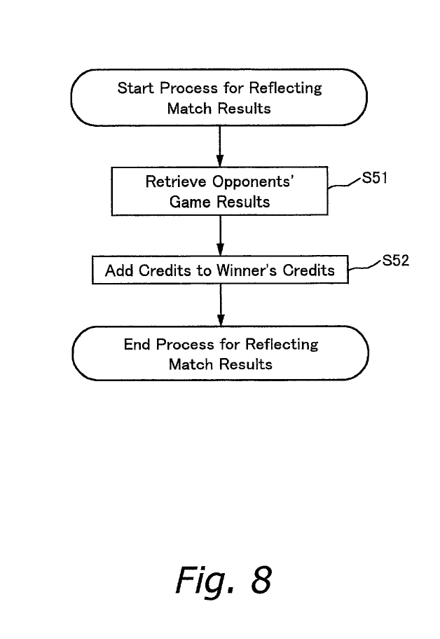

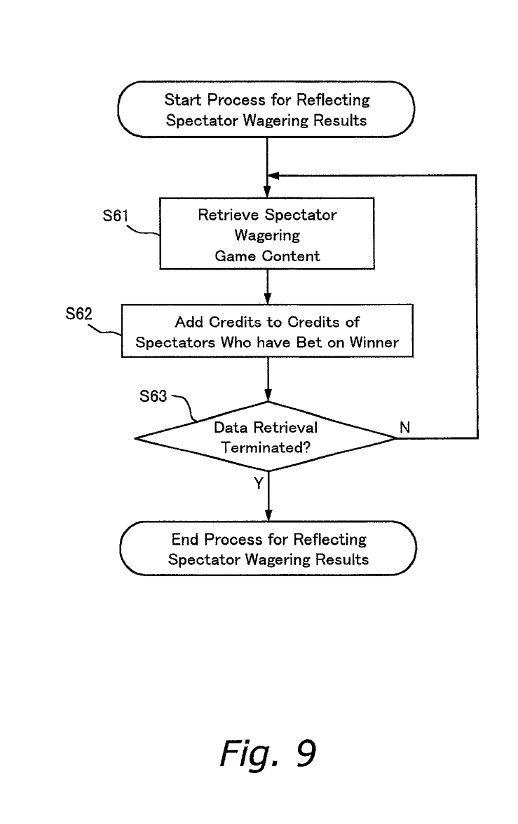

In addition to the above-described processes, the ID registration/credit management processing unit 12 also performs a process for reflecting the match results (Step S5) and a process for reflecting the spectator wagering results (Step S7) shown in FIG. 4, following the flowcharts shown in FIGS. 8 and 9. As shown in FIG. 8, the ID registration/credit management processing unit 12 first retrieves the opponents' game results from the personal information storage unit 19 (Step S51), and after the credits at stake have been added to the credits of the winning player, the players' credit count stored in the personal information storage unit 19 is updated with the credit count resulting from this calculation (Step S51). Then, the process is terminated.

Then, as shown in FIG. 9, the ID registration/credit management processing unit 12 sequentially retrieves the spectator-wagering game information of each spectator stored in the spectator content storage unit 24 (Step S61), and if a spectator has placed a bet on the winning player, then the credit count bet by this spectator is multiplied by the payoff ratio, the resulting payoff is added to the spectator's credit count, and the spectator's credit count stored in the personal information storage unit 19 is updated with the credit count resulting from this calculation (Step S62). After the same process has been carried out for all spectators (Step S63), the process is terminated.

The player information distribution process module 18 distributes image data and audio data, which it receives from the terminal management devices 31 over the network 2, to the other terminal management devices 31, again over the network 2. The terminal management devices 31 output the received image data and audio data to the connected speakers 37, which regenerate the audio signals, and monitors 38, which display the video signals.

Thus, with a game system 1 having this configuration, a player first sends personal identification information over an entry-processing device 39 to a central administrator 10, receives an assigned ID number, and by investing a discretionary amount of money into the entry-processing device 39, a predetermined credit count is issued in consideration of the currency exchange rate. Then, the central administrator 10 stores the ID number, the identification information, and the issued credit count in the personal information storage unit 19.

Thus, after the player has registered particular data, the player can participate in match-type games or spectator-wagering games using the game machine 30, by inputting his or her personal identification information with the terminal management device 31. Needless to say, the user can play a game by accessing the terminal management device 31 set up at any desired location. Moreover, the player can buy additional credits by investing a further discretionary amount of money into the entry-processing device 39.

When a player inputs his or her personal identification information, the central administrator 10 starts the game execution process shown in FIG. 4. First, the credit count necessary for executing the game is subtracted from the player's credit count, and then the player inputs through the terminal management device 31 the type of game he or she wishes to play, that is, whether a match-type game or a spectator-wagering game is to be carried out (Step S1). If the player wishes to play a match-type game, then the match content is determined by sequentially processing Steps S2 and S3, and then the player plays the game using the game machine 30 (Step S4). The execution of the game can be such that a plurality of players play a match-type game in real-time, or such that the players execute the game at different times. If the game is played in real-time, then the player information input with the cameras 34 and the microphones 35 is distributed among the terminal management devices 31, so that an image of the opponent is displayed on the monitor 38 and the opponent's voice is output through the speaker 37, which gives the opponent the impression of being actually present at the site of the game. Also if the game is played at different times, the information of the player executing the game first can be distributed to the terminal management device 31 of a player executing the game later, which gives the later player the impression of being actually present at the site of the game. In this example, a “one-on-one” match has been described, but it is of course also possible that three or more players participate in a match.

If, however, the player wishes to participate in a spectator-wagering game, then the spectator-wagering game content is configured by executing the process in Step S8. Also in this case, if, after setting the game content, information on the competing players is distributed to the spectators' terminal management devices 31, then the spectators can similarly participate in the game under the impression that they are actually present at the site of the game.

Thus, when the game is executed, the central administrator 10 performs the process for reflecting the match results described above (Step S5) and then (with the handicap calculation unit 16) performs a process for updating the handicaps stored in the personal information storage unit 19 for each player taking part in a game, based on the game results (Step S6). Then, after carrying out the process for reflecting the spectator results (Step S7) described above, the game execution process is terminated.

Thus, when a plurality of players play against one another with the game system 1 of this example, they can bet their own game execution credits, so that the players can participate in the game in an environment in which the result (that is, the outcome) of the game is linked to the player's advantage or disadvantage by increasing or decreasing the player's game execution credits, so that the game can be played while maintaining a continual sense of excitement. Consequently, this solves the problem of the prior art, that by repeating the same game a number of times, a certain routine will set in, wearing down the interest in the game.

If the opponents' skill levels are too different, then a player can predict the outcome of the game too easily when betting credits as described above, so that the excitement of the game erodes and interest in the match is lost, but with the game system 1 of this example, handicaps can be assigned in accordance with the players' skills, and the outcome has to be predicted giving consideration to the handicaps. Therefore the outcome of the game is not so easy to predict after all, so that the players maintain a sense of excitement for the game, and do not loose their interest in matches.

If entry-processing devices 39 are located in another country, then the credit count issued for a payment is adjusted in accordance with the currency exchange rate of that country, which means that the value of one credit is set to be equivalent in all countries, so that when players (including game spectators) from different countries compete while betting their credits against one another, the payoffs can be set to be equivalent for all players.

By betting their credits, third party players (spectators) who are not the competing players can participate indirectly in the game, so they can enjoy the game from a different angle by trying to predict the outcome of the game and rooting for the player they have placed their bet on.

In this example, the credits are issued in the central administrator 10, but it is also possible that the credits are issued in the entry-processing device 39. In that case, the entry-processing device 39 acquires the currency exchange rate of its country (the country where the entry-processing device 39 is located) from the central administrator 10, and issues the credits in consideration of this currency exchange rate.

Also, in this example, the process of subtracting the game execution credits from the player's credits is performed in the central administrator 10, but this process can also be performed in the terminal management devices 31. In that case, the data relating to the game execution credits are held separately in each of the corresponding terminal management devices 31.

Second Embodiment

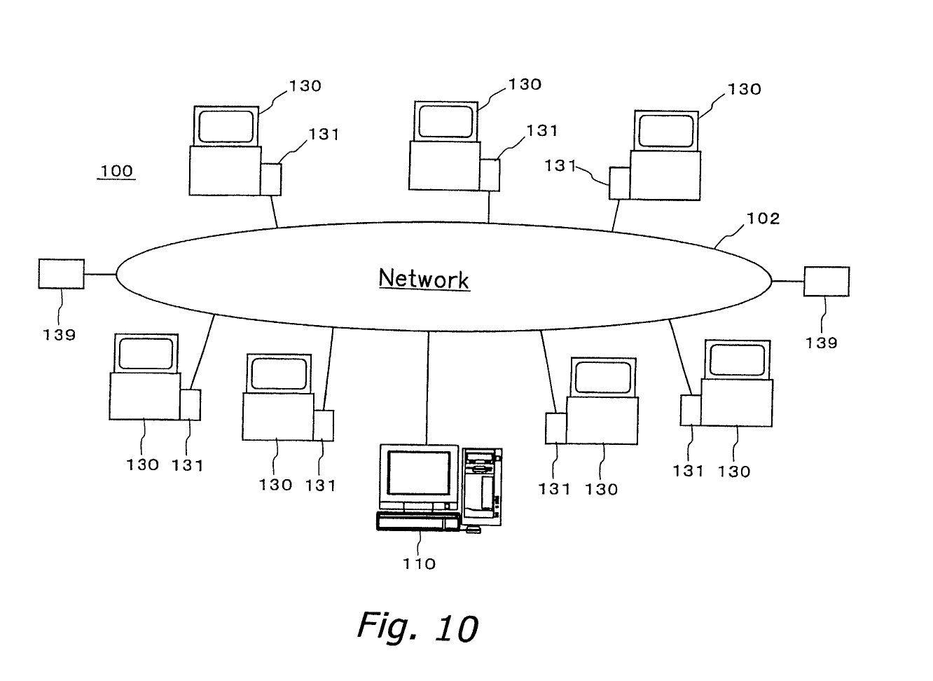

The second embodiment of the present invention is explained with reference to FIGS. 10 through 18. FIG. 10 illustrates the general configuration of a game system in accordance with this second embodiment.

As shown in FIG. 10, a game system 100 in accordance with this example includes a plurality of game machines (game terminal devices) 130 and terminal management devices 131 linked to the game machines 130, the game machines 130 and terminal management devices 131 being provided at game arcades or at private homes, as well as entry-processing devices 139 and a central administrator 110. All these devices are connected by a network 102, such as the internet. The game machines 130 can be large commercial game machines as installed in game arcades, small game machines for home use, or game devices using a personal computer. The game machines 130 are connected to the network 102 via the terminal management devices 131.

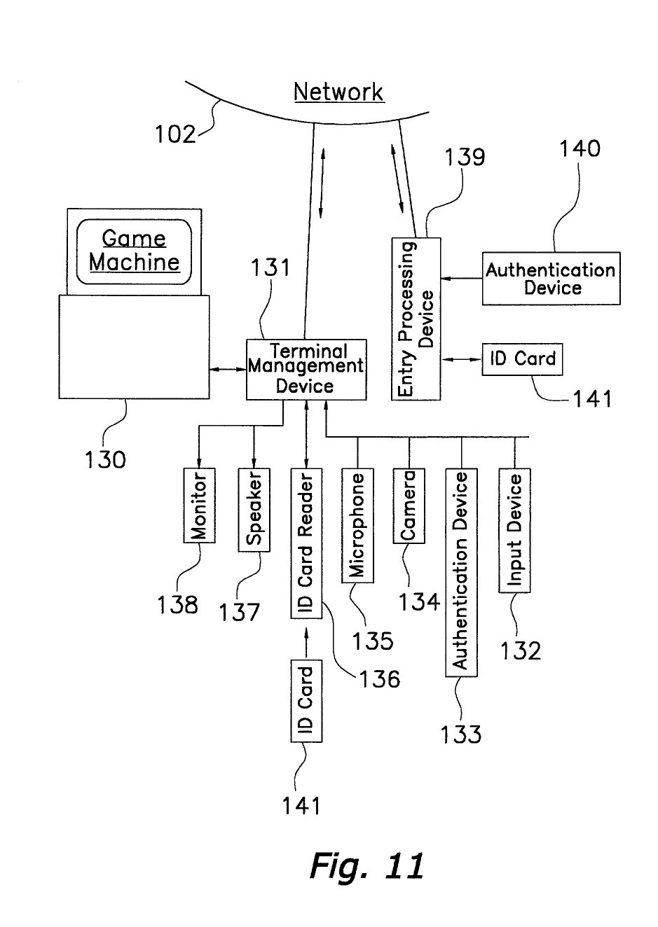

As shown in FIG. 11, a terminal management device 131 is connected to an input device 132, an authentication device 133, a camera 134, a microphone 135, an ID card reader 136, a speaker 137, and a monitor 138. The terminal management device 131 sends data that are input with the input device 132, the authentication device 133, the camera 134, the microphone 135, and the ID card reader 136 to the central administrator 110 and outputs data that it receives from the central administrator 110 to the ID card reader 136, the speaker 137 and the monitor 138. The camera 134 is arranged to pick up the player's facial expression, and the microphone 135 is arranged to pick up the player's voice.

The ID card reader 136 reads the data stored in an ID card 141, sending the data to the terminal management device 131, but also updates the data stored in the ID card 141 with the data received from the terminal management device 131. The ID card 141 is a portable card, and contains initial data written onto it by the entry-processing device 139. The entry-processing device 139 is connected over the network 102 to the central administrator 110 and sends the personal identification information of the player that has been obtained with the authentication device 140 to the central administrator 110, receives the ID number associated with this identification information that has been assigned by the central administrator 110, and stores the received ID number onto the ID card 141. The entry-processing device 139 also collects payments from players, stores on the ID card 141 the credit count corresponding to the payments, and sends this credit count to the central administrator 110. The authentication device 140 has the same function as the afore-mentioned authentication device 133, and these authentication devices can acquire identification information, such as an image of the player's face, a fingerprint or a voiceprint.

When an ID card 141 is connected to the ID card reader 136 and a game application signal is input with the input device 132, then the terminal management device 131 performs a game execution entry process. That is, the credit count that is necessary for executing a game (including spectator-wagering games) is subtracted from the credit count stored on the ID card 141, the credit count stored on the ID card 141 is updated via the ID card reader 136 with the resulting credit count, and the game machine 130 is readied for executing the game. The updated credit count and the ID number of the player that has been read in from the ID card 141 with the ID card reader 136 are sent to the central administrator 110, together with the identification information of the player obtained with the authentication device 133.

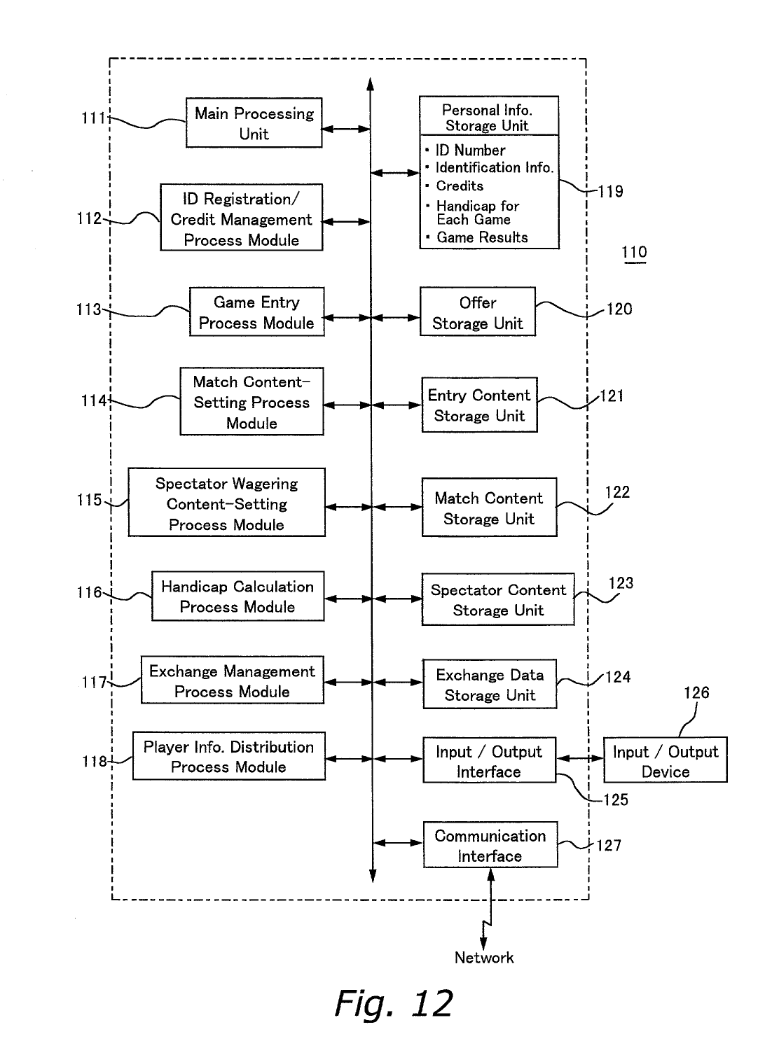

As shown in FIG. 12, the central administrator 110 includes a number of processing units, namely: a main processing unit 111, an ID registration/credit management processing unit 112, a game entry processing unit 113, a match content setting process module 114, a spectator-wagering content setting process module 115, a handicap calculation process module 116, an exchange management process module 117, and a player information distribution process module 118, as well as a personal information storage unit 119, an offer storage unit 120, an entry information storage unit 121, a match content storage unit 122, a spectator (participation) content storage unit 123, an exchange data storage unit 124, an input/output interface 125, and a communication interface 127, all of which are connected over a bus line. An input/output device 126 is connected to the input/output interface 125. The network 102 is connected via the communication interface 127.

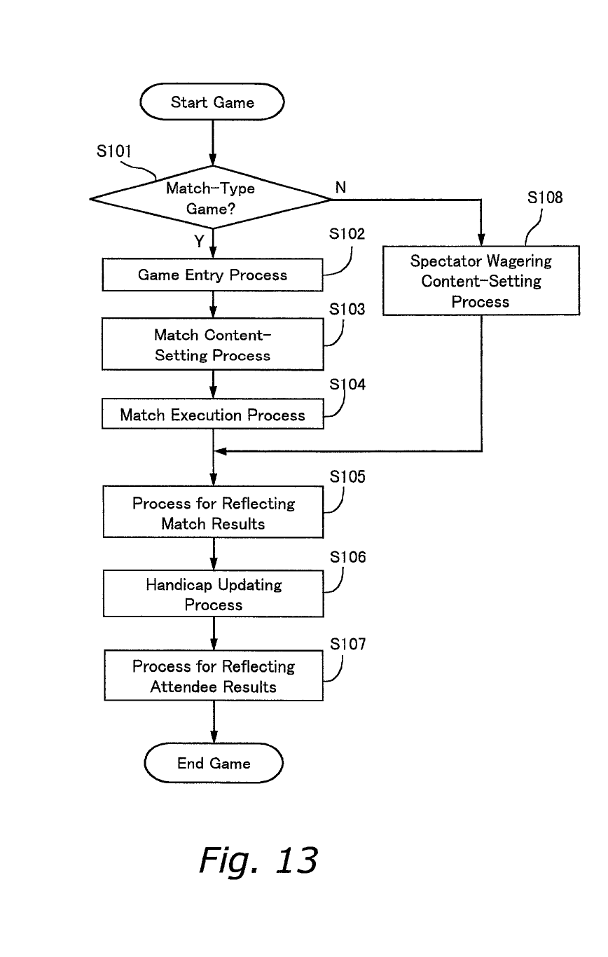

The main processing unit 111 gives process execution commands to the ID registration/credit management processing unit 112, the game entry processing unit 113, the match content setting process module 114, the spectator-wagering content setting process module 115, the handicap calculation process module 116, the exchange management process module 117, and the player information distribution process module 118, and performs the game execution process shown in FIG. 13.

The function of the personal information storage unit 119 is to store for each player such data as ID number, identification information, credits, as well as handicap, results and ranking for each game. The ID registration/credit management processing unit 112 receives the identification in-formation and the issued credit count from the entry-processing device 139, and if the identification information is not yet registered, then the ID registration/credit management processing unit 112 assigns an ID number associated with the identification information, sends this ID number to the entry-processing device 139, and stores the identification information, the ID number and the issued credit count in the personal information storage unit 119. If, on the other hand, the identification information already has been registered, then the received credit count issued is added to the credit count associated with the identification information stored in the personal information storage unit 119. The credit count that has been updated by the terminal management device 131 when accepting the execution of a game is received from that terminal management device 131, and the credit count associated with the identification information stored in the personal information storage unit 119 is updated with the received new credit count.

For each game, the handicap calculation process module 116 retrieves the game result data stored in the personal information storage unit 119, adds up the game results, such as the scores, that a player has achieved over, for example, the last five games, calculates the average score, and subtracts the average score of that player from the average score of the player with the highest average score, to calculate the handicap of that player for that game. Then the calculated handicap for each game is stored in the personal information storage unit 119. If a player has completed less than five games, then that player's handicap is set to a predetermined initial value.

The exchange management process module 117 stores the currency exchange rates for all relevant countries (which have been input with the input/output device 126 or obtained through the network 102) in the exchange data storage unit 124, and updates the exchange data stored in the exchange data storage unit 124 in periodical or non-periodical intervals. Then, the entry-processing device 139 obtains the currency exchange rate for its country (the country where the entry-processing device 139 is located), which is stored in the exchange data storage unit 124, and adjusts the credit count issued in accordance with this currency exchange rate. To give a specific example for issuing a credit count in consideration of the currency exchange rate, if for example one dollar is equivalent to ten credits, and the present currency exchange rate for Japanese Yen is one US Dollar to 110 Japanese Yen, then ten credits are issued in Japan for each 110 Yen. Similarly, credits are issued in accordance with the currency exchange rate for other countries as well.

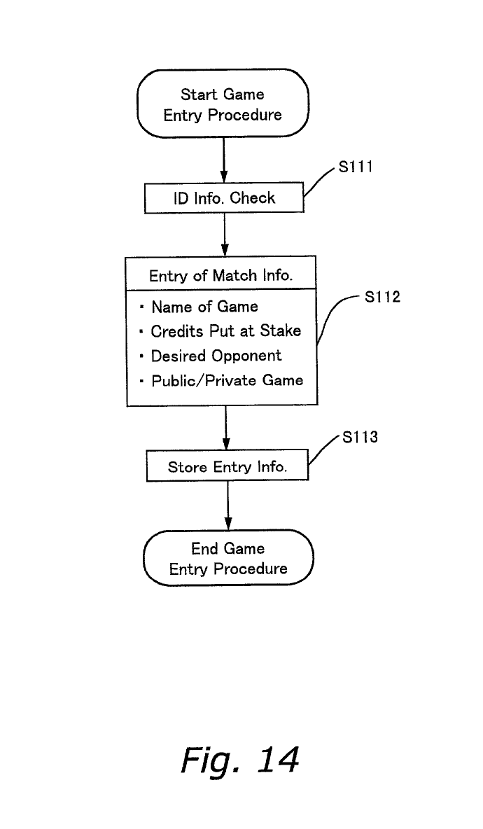

The game entry processing unit 113 performs the game entry process (Step S102) shown in FIG. 13, following the flowchart shown in FIG. 14. That is, as shown in FIG. 14, the game entry processing unit 113 first receives an ID number and identification information from the terminal management device 131 and compares the received identification information with the identification information stored in the personal information storage unit 119 to confirm the identity of the player (to confirm the identity of the person holding the ID card 141, that is, whether he or she is rightfully holding the ID card 141) (Step S111). Then, the game entry processing unit 113 queries the player through the terminal management device 131 to input such game information as the game's name, credits put at stake, desired opponent, public or private game (Step S112), and stores the entered game information in the entry information storage unit 121. If the desired opponent is available, it also stores the entry information in the offer storage unit 120 (step S113), whereafter the process is terminated.

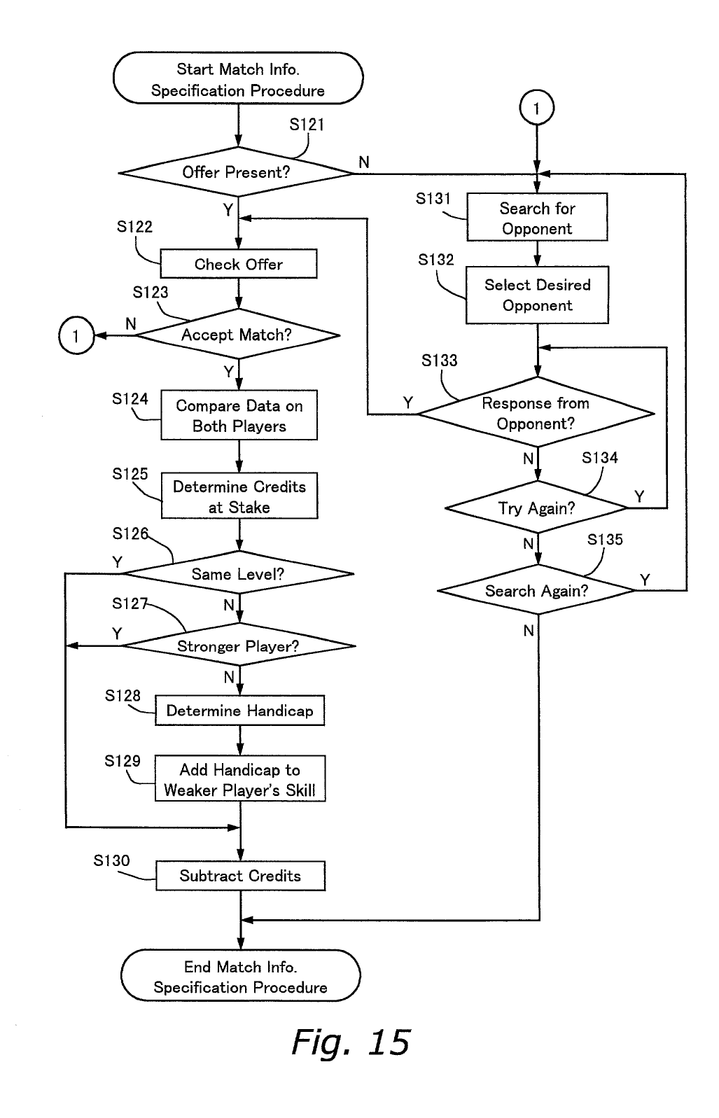

Following the flowchart shown in FIG. 15, the match content setting process module 114 performs the match content setting process indicated in FIG. 13 (Step S103). That is, as shown in FIG. 15, the match content setting process module 114 first searches the entry information stored in the offer storage unit 120 to check whether there is an application for a match against the player (Step S121), and if there is such an application, it exchanges the corresponding entry information (offer information) between the terminal management devices 131 used by the players, where it is displayed on the monitor 138, and it is checked whether the players intend to accept the match (Steps S122 and S123).

Then, if players are willing to enter into the match, the entry content for the two competitors is compared (Step S124), and the bet credit number for the given match is set to the lower of the bet credit numbers (Step S125). Then whether the skill rating (handicap) of the two players is the same is determined (Step S126). If the skill rating of the two players is different, then the difference between the handicaps of both players is taken as the handicap for this game and this calculated handicap is assigned to the player with the lower rating (player with the larger handicap) (Steps S127 to S129), and the process is terminated. No handicap is assigned to the player who is determined by Step S127 to have the larger skill level. If, on the other hand, Step S126 determines that the skill rating of the two players is about the same, then no handicap is assigned. After carrying out this handicap assignment process, a process is performed to subtract the number of staked credits from the players' credit count (Step S130). Specifically, an update command is given to the ID registration/credit management processing unit 112, whereby the credit count stored in the personal information storage unit 119 is updated with the credit count resulting from this subtraction. The update command and the credit count resulting from the subtraction are also sent to the terminal management device 131, and the credit count stored on the ID card 141 is updated with this credit count.

If Step S121 determines that there is no application for a match, then a list of registered players is sent to the terminal management device 131 used by the player, where it is displayed on the monitor 138, so that the player can search for potential opponents (Step S131), and select the desired opponent (Step S132). If there is a response from the selected opponent, then the process jumps to Step S122 (Step S133). If there is no response from the selected opponent, then whether the player intends to try again is checked (Step S134). If the player does not intend to try again, whether the player intends to search for another opponent is checked (Step S135). If the player intends to search for another opponent, then the process jumps to Step S131, and if the player does not intend to search for another opponent, then the process is terminated. If at Step S123 either one of the players does not accept the match, then the process jumps to Step S131. Then the match content specified in this manner is stored in the match content storage unit 122.

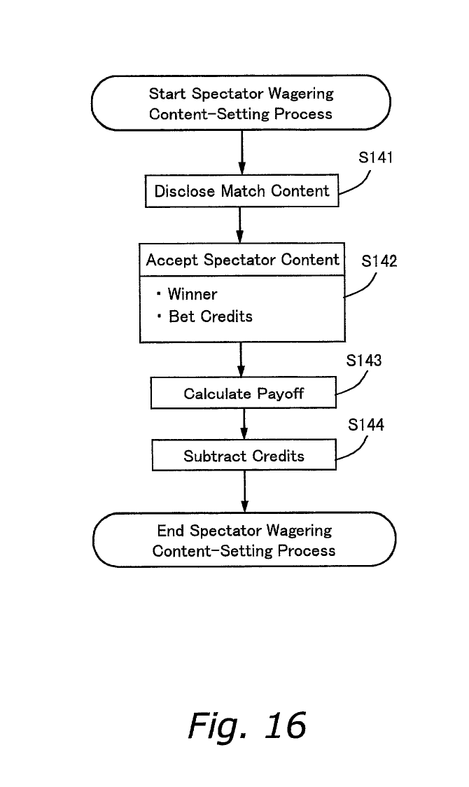

Following the flowchart shown in FIG. 16, the spectator-wagering content setting process module 115 performs the spectator-wagering game content-setting process indicated in FIG. 13 (Step S108). That is, in response to a request from a terminal management device 131 used by a third party (who is not one of the competing players; referred to as “spectator” below), the spectator-wagering content setting process module 115 first sends the match content on the set-up game to the terminal management device 131, and discloses the match content to this spectator (Step S141), as shown in FIG. 16. Then, spectator participation content is collected from the spectators' terminal management devices 131 (Step S142). The spectator participation content that is collected from the spectators' terminal management devices 131 is which one of the competing players a spectator predicts will win, and how many credits the spectator bets on the victory of this player. After the payoff for the wager has been calculated (Step S143), the afore-mentioned credit count put at stake is subtracted from the spectator's credit count (Step S144). More specifically, an update command is given to the ID registration/credit management processing unit 112, whereby the spectator's credit count stored in the personal information storage unit 119 is updated with the credit count resulting from this subtraction. The update command and the credit count resulting from the subtraction are also sent to the terminal management device 131, and the spectator's credit count stored on the ID card 141 is updated with this credit count. Then, the process is terminated. The spectator game (third-party wagering) information configured in this manner is stored in the spectator content storage unit 123.

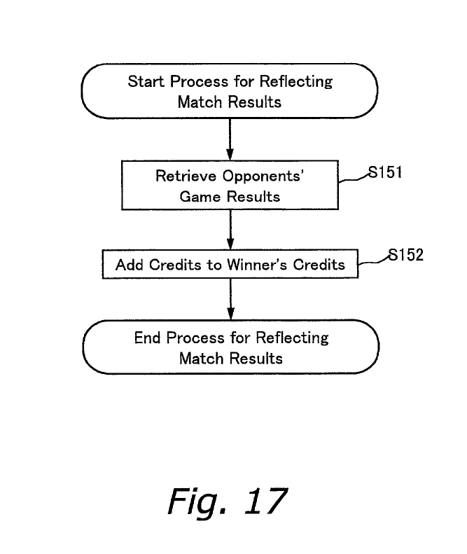

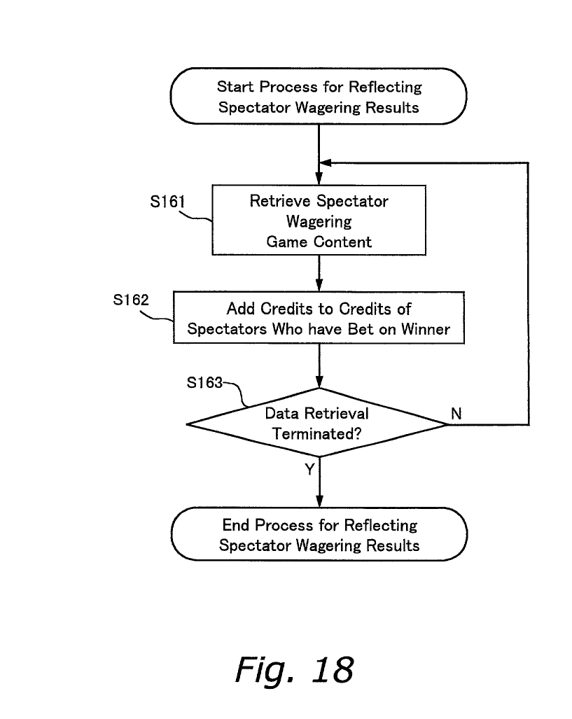

In addition to the above-described processes, the ID registration/credit management processing unit 112 also performs a process for reflecting the match results (Step S105) and a process for reflecting the spectator wagering results (Step S107) shown in FIG. 13, following the flowcharts shown in FIGS. 17 and 18. As shown in FIG. 17, the ID registration/credit management processing unit 112 first retrieves the opponents' game results from the personal information storage unit 119 (Step S151), and after the credits at stake have been added to the credits of the winning player, the players' credit count stored in the personal information storage unit 119 is updated with the credit count resulting from this calculation, the credit count resulting from the subtraction is also sent to the terminal management device 131 used by the player, and the credit count stored on the ID card 141 is updated (Step S152). Then, the process is terminated.

Then, as shown in FIG. 18, the ID registration/credit management processing unit 112 sequentially retrieves the spectator-wagering game information of each spectator stored in the spectator content storage unit 123 (Step S161), and if a spectator has placed a bet on the winning player, then the credit count bet by this spectator is multiplied by the payoff ratio, the resulting payoff is added to the spectator's credit count, and the spectator's credit count stored in the personal information storage unit 119 is updated with the credit count resulting from this calculation. The credit count resulting from this calculation is also sent to the terminal management device 131 used by the spectator, and the credit count stored on the spectator's ID card 141 is updated (Step S162). After the same process has been carried out for all spectators (Step S163), the process is terminated.

The player information distribution process module 118 distributes image data and audio data, which it receives from the terminal management devices 131 over the network 102, to the other terminal management devices 131, again over the network 102. The terminal management devices 131 output the image data and audio data to the connected speakers 137, which regenerate the audio signals, and monitors 138, which display the video signals.

Thus, with a game system 100 having this configuration, a player first buys an ID card 141 that can be connected to an entry-processing device 139 and an ID card reader 136. The ID card 141 is connected to the entry-processing device 139, the player then sends personal identification information via the entry-processing device 139 to the central administrator 110, receives an assigned ID number, and by investing a discretionary amount of money into the entry-processing device 139, a predetermined credit count is issued under consideration of the currency exchange rate. This means that the entry-processing device 139 writes this credit count onto the ID card 141. Then, with this process, the central administrator 110 stores the ID number, the identification information, and the issued credit count received from the entry-processing device 139 in the personal information storage unit 119.

Thus, after the player has registered particular data, the player can participate in match-type games or spectator-wagering games using a game machine 130, by connecting the ID card 141 with which the issued credits have been received from the entry-processing device 139 to the ID card reader 136 of the terminal management device 131. Needless to say, because the ID card 141 is a portable card, which the user can take to any desired location and play a game by connecting it to a terminal management device 131 set up at that location. The player also can buy additional credits by investing a further discretionary amount of money into the entry-processing device 139.

When a player connects his or her ID card 141 to a terminal management device 131, the central administrator 110 searches the player's identification information stored in the personal information storage unit 119, based on the player's ID number input via the card reader 136 belonging to the terminal management device 131, and compares the player's identification information input via the authentication device 133 belonging to the terminal management device 131 with the retrieved identification information of the player, to verify the player's identity. If the identity of the player cannot be verified, a message to the effect that the start of the game is denied is displayed on the monitor belonging to the terminal management device 131, and the process is terminated.

On the other hand, if the player's identity could be verified, then the central administrator 110 starts the game execution process shown in FIG. 13. This means the player inputs via the terminal management device 131 the type of game he or she wishes to play, that is, whether a match-type game or a spectator-wagering game is carried out (Step S101). If the player wishes to play a match-type game, then the match content is determined by sequentially processing Steps S102 and S103, and then the player plays the game on his or her game machine 130 (Step S104). The execution of the game can be such that a plurality of players play a match-type game in real-time, or that the players execute the game at different times. If the game is played in real-time, then the player information input with the cameras 134 and the microphones 135 is distributed among the terminal management devices 131, an image of the opponent is displayed on the monitor 138, and the opponent's voice is output with the speaker 137, which gives the opponents the impression of being actually present at the site of the game. Also if the game is played at different times, the information of the player executing the game first can be distributed to the terminal management device 131 used by the player executing the game later, which gives the later player the impression of being actually present at the site of the game. In this example, a “one-on-one” match has been described, but it is of course also possible that three or more players participate in the match.

If on the other hand the player wishes to participate in a spectator-wagering game, then the spectator-wagering game content is configured by executing the Step S108 process. Also in this case, if, after setting the game content, information on the competing players is distributed to the spectators' terminal management devices 131, then the spectators can similarly participate in the game under the impression that they are actually present at the site of the game.

Thus, when the game is executed, the central administrator 110 performs the process for reflecting the match results (Step S105) and then (with the handicap calculation unit 116) a process for updating the handicaps stored in the personal information storage unit 119 for each competing player, based on the game results (Step S106). Then, after carrying out the process for reflecting the spectator results described above (Step S107), the game execution process is terminated.

Thus, when a plurality of players play against one another with the game system 100 of this example, they can participate in a match, betting their own game execution credits, so that the players can participate in the game in an environment in which the result (that is, the outcome) of the game is linked to the player's advantage or disadvantage by increasing or decreasing the player's game execution credits, so that the game can be played while maintaining a continual sense of excitement. Consequently, this solves the problem of the prior art, that by repeating the same game a number of times, a certain routine will set in, wearing down the interest in the game.

If the opponents' skill levels are too different, then a player can predict the outcome of the game too easily when betting credits as described above, so that the excitement of the game erodes and interest in the match is lost, but with the game system 100 of this example, handicaps can be assigned in accordance with the players' skills, and the outcome has to be predicted giving consideration to the handicaps. Therefore the outcome of the game is not so easy to predict after all, so that the players maintain a sense of excitement for the game and do not loose their interest in matches.

If entry-processing devices 139 are located in another country, then the credit count issued by those entry-processing devices 139 are adjusted in accordance with the currency exchange rate of that country, which means that the value of one credit is set to be equivalent in all countries, so that when players from different countries (including game spectators) compete, betting their credits against one another, the payoffs can be set to be equivalent for all players.

By betting their credits, third party players (spectators) who are not the competing players can participate indirectly in the game, so they can enjoy the game from a different angle by trying to predict the outcome of the game and rooting for the player they have placed their bet on.

If the game machines 30 and 130 in the first and second embodiments are TV game machines, then it is also possible to provide the central administrators 10 and 110 with a game program storage unit and a game program distribution processing unit, store several kinds of game programs in the game program storage unit, send the game program requested by the player via the terminal management devices 31 and 131 to those terminal management devices 31 and 131 by processing with a game program distribution processing unit, and download the game program from the terminal management devices 31 and 131 to the game machines 30 and 130 connected thereto, so that the downloaded game program can be executed on the game machines 30 and 130. With this configuration, a plurality of different games can be performed on one game machine 30 or 130. In this case, if the distributed game program can also constitute a virtual game arcade in the game machine 30 or 130, then the player can participate in games of this virtual game arcade. Thus, the player can play a game under the impression that the game takes place in a game arcade, even though the game machines 30 and 130 are located outside a game arcade, for example at the player's home.

Moreover, the games executed on the game systems 1 and 100 of the first and second embodiments can also include educational information. For example, it is possible to take the solving of mathematical problems, a quiz on historical facts or other questions appearing in school tests as the subject of a game, and let the players compete in giving the fastest answer or striving for the highest ratio of correct answers. In this way, such educational information can be gained very effectively, since the object of enticing interest is the players, who are exposed to educational information through the medium of a game by which the information can be grappled with in earnest.

Mobile phones may be used for investing money via the entry-processing devices 39, 139 of the foregoing embodiments. Alternatively, a mobile phone may constitute the entry-processing device, in which case the credit count should be set in the central administrating device, (not in the mobile phone itself). In this case, as in the foregoing embodiments likewise, players and spectator wagerers may play and wager on the games with virtual credits.

It should be understood that based on the game systems as described in the foregoing, players may compete in match-type games with one another in real time, or at staggered times, which might particularly depend on the nature of the game played, e.g., point-based games would be suited to staggered play. Further, the central administrator may be configured to refrain from issuing a game-executable signal until it has received a given player (and spectator-wagerer) wager total or competing player total from the entry-processing device(s).

While only selected embodiments have been chosen to illustrate the present invention, to those skilled in the art it will be apparent from this disclosure that various changes and modifications can be made herein without departing from the scope of the invention as defined in the appended claims. Furthermore, the foregoing description of the embodiments according to the present invention is provided for illustration only, and not for the purpose of limiting the invention as defined by the appended claims and their equivalents.

What is claimed is:

1. A player credit-wagering network game system enabling a plurality of players to conduct a game via the network, the network game system comprising:
a central administrating device;
a plurality of game terminal devices;
a plurality of terminal management devices linked-attached respectively to said plurality of game terminal devices;
at least one communications medium interconnecting said central administrating device and said plurality of game terminal devices;
an entry-processing device connected via the communications medium to said central administrating device, for accepting identification information on the players and sending the thus given player identification information to said central administrating device, and for accepting payment from without said entry-processing device and sending information on the accepted payment to said central administrating device;
said terminal management devices being configured
to receive identification information on the players and send the player identification information to said central administrating device for enabling execution of a game on said game terminal devices on receiving a game-executable signal from said central administrating device; and
said central administrating device being configured to receive the given player identification information together with the accepted payment information sent from said entry-processing device and based on the accepted payment information establish a credit count, and to store correlatively the credit count with the given player identification information, as the credit counts given players own
when player identification information is received from a said terminal management device and the credit counts given players own meet a predetermined credit count necessary for execution of a game on said game terminal devices, to deduct the game-execution credits from the credit counts the given players own, update the credit counts the given players own with the calculated credit counts, and meanwhile send a game-executable signal to the said terminal management device, and
to establish via the said terminal management device wagered credits wherein the credit count given players own is credited/deducted depending on game results, the wagered credits being established correspondingly among the players, and in accordance with the game result to credit/deduct by the wagered credits the credit counts the given players own and update the credit counts the given players own with the calculated credit counts.

2. A game system as set forth in claim 1, said central administrating device comprising a handicap setting process unit for establishing handicaps in accordance with players' skill; wherein the game system is configured such that the outcome of games is determined making allowance for the established handicaps.

3. A game system as set forth in claim 1, wherein the credit count established according to the payment accepted by said entry-processing device is adjusted according to national currency exchange rate where the entry-processing device is installed.

4. A game system as set forth in claim 1, said central administrating device, wherein wagered credits are established correspondingly among third party players apart from those players executing the game, being further configured:
to establish via said terminal management devices wagered credits by crediting/deducting the credit counts the third parties own depending on the game result; and
according to the game result to credit/deduct by the wagered credits the credit counts the third parties own, and update the credit counts the third parties own with the calculated credit counts.

5. A game system as set forth in claim 1, wherein said central administrating device stores a game program, and the game system is set up to distribute the game program from said central administrating device to said game terminal devices.

6. A game system as set forth in claim 1, wherein games executed on the game system include educational information.

7. A player credit-wagering network game system enabling a plurality of players to conduct a game via the network, the network game system comprising:
a central administrating device;
a plurality of game terminal devices;
a plurality of terminal management devices linked-attached respectively to said plurality of game terminal devices;
at least one communications medium interconnecting said central administrating device and said plurality of game terminal devices;
an entry-processing device connected via the communications medium to said central administrating device, said entry-processing device being configured to accept identification information on the players and send the thus given player identification information to said central administrating device, and to accept payments from without said entry-processing device and establish credit counts based on and in response to the accepted payment sums, and to send the established credit counts to said central administrating device;
said terminal management devices being configured
to accept identification information on the players and send the player identification information to said central administrating device for enabling execution of a game on said game terminal devices on receiving a game-executable signal from said central administrating device; and
said central administrating device being configured to receive the established credit counts and the given player identification information from said entry-processing device, and store correlatively the established credit counts with the given player identification information, as the credit counts given players own,
when player identification information is received from a said terminal management device and the credit counts given players own meet a predetermined credit count necessary for execution of a game on said game terminal devices, to deduct the game-execution credits from the credit counts the given players own, update the credit counts the given players own with the calculated credit counts, and meanwhile send a game-executable signal to the said terminal management device, and
to establish via the said terminal management device wagered credits wherein the credit count given players own is credited/deducted depending on game results, the wagered credits being established correspondingly among the players, and in accordance with the game result to credit/deduct by the wagered credits the credit counts the given players own and update the credit counts the given players own with the calculated credit counts.

8. A game system as set forth in claim 7, said central administrating device comprising a handicap setting process unit for establishing handicaps in accordance with players' skill; wherein the game system is configured such that the outcome of games is determined making allowance for the established handicaps.

9. A game system as set forth in claim 7, wherein the credit count established according to the payment accepted by said entry-processing device is adjusted according to national currency exchange rate where the entry-processing device is installed.

10. A game system as set forth in claim 7, said central administrating device, wherein wagered credits are established correspondingly among third party players apart from those players executing the game, being further configured:
to establish via said terminal management devices wagered credits by crediting/deducting the credit counts the third parties own depending on the game result; and
according to the game result to credit/deduct by the wagered credits the credit counts the third parties own, and update the credit counts the third parties own with the calculated credit counts.

11. A game system as set forth in claim 7, wherein said central administrating device stores a game program, and the game system is set up to distribute the game program from said central administrating device to said game terminal devices.

12. A game system as set forth in claim 7, wherein games executed on the game system include educational information.

13. A player credit-wagering network game system enabling a plurality of players to conduct a game via the network, the network game system comprising:
a central administrating device;
a plurality of game terminal devices;
a plurality of terminal management devices linked-attached respectively to said plurality of game terminal devices;
at least one communications medium interconnecting said central administrating device and said plurality of game terminal devices;
an entry-processing device connected via the communications medium to said central administrating device, for accepting identification information on the players and sending the thus given player identification information to said central administrating device, and for accepting payment from without said entry-processing device and sending information on the accepted payment to said central administrating device;
said terminal management devices being configured
to receive identification information on the players and send the player identification information to said central administrating device for enabling execution of a game on said game terminal devices on receiving a game-executable signal from said central administrating device, and receive from said central administrating device credit counts given players own, and
when credit counts given players own meet a predetermined credit count necessary for execution of a game on said game terminal devices, to deduct the game-execution credits from the owned credit count, send the thus calculated credit counts to said central administrating device, and meanwhile enable game-execution in said game terminal devices; and
said central administrating device being configured
to receive the given player identification information together with the accepted payment information sent from said entry-processing device and based on the accepted payment information establish a credit count, to store correlatively the credit count with the given player identification information, as the credit counts given players own, and to send the credit counts the given players own to said terminal management devices,
to send to said terminal management devices the credit count given players own on receiving player identification information from said terminal management devices, and to receive the calculated credit counts from said terminal management devices and update the credit counts the given players own with the calculated credit counts, and meanwhile send a game-executable signal to said terminal management devices, and
to establish via the said terminal management device wagered credits wherein the credit count given players own is credited/deducted depending on game results, the wagered credits being established correspondingly among the players, and in accordance with the game result to credit/deduct by the wagered credits the credit counts the given players own and update the credit counts the given players own with the calculated credit counts.

14. A game system as set forth in claim 13, said central administrating device comprising a handicap setting process unit for establishing handicaps in accordance with players' skill; wherein the game system is configured such that the outcome of games is determined making allowance for the established handicaps.

15. A game system as set forth in claim 13, wherein the credit count established according to the payment accepted by said entry-processing device is adjusted according to national currency exchange rate where the entry-processing device is installed.

16. A game system as set forth in claim 13, said central administrating device, wherein wagered credits are established correspondingly among third party players apart from those players executing the game, being further configured:
to establish via said terminal management devices wagered credits by crediting/deducting the credit counts the third parties own depending on the game result; and
according to the game result to credit/deduct by the wagered credits the credit counts the third parties own, and update the credit counts the third parties own with the calculated credit counts.

17. A game system as set forth in claim 13, wherein said central administrating device stores a game program, and the game system is set up to distribute the game program from said central administrating device to said game terminal devices.

18. A game system as set forth in claim 13, wherein games executed on the game system include educational information.

19. A player credit-wagering network game system enabling a plurality of players to conduct a game via the network, the network game system comprising:
a central administrating device;
a plurality of game terminal devices;
a plurality of terminal management devices linked-attached respectively to said plurality of game terminal devices;
at least one communications medium interconnecting said central administrating device and said plurality of game terminal devices;
player-portable recording mediums for recording credits used at least for executing games;
an entry-processing device, connected via the communications medium to said central administrating device, and set up to be connectable with the portable recording mediums, for accepting payments from without said entry-processing device and writing into said portable recording mediums credit counts established according to the payments;
said terminal management devices being configured
by connecting with the portable recording mediums, to carry out a game execution entry process, deduct from the credit counts stored on the portable recording mediums a predetermined credit count necessary for executing a game, update the credit counts stored on the portable recording mediums with the calculated credit counts, and enable execution of the game on said game terminal devices; and
said central administrating device being configured
via said terminal management devices to establish wagered credits wherein the credit counts stored on the portable recording mediums are credited/deducted depending on the game result, the wagered credits being established correspondingly among the players,
and in accordance with the game result credit/deduct by the wagered credits the credit counts the players own, and via said terminal management devices update the owned credit count the players own stored on the portable recording mediums with the calculated credit counts.

20. A game system as set forth in claim 19, said central administrating device comprising a handicap setting process unit for establishing handicaps in accordance with players' skill; wherein the game system is configured such that the outcome of games is determined making allowance for the established handicaps.

21. A game system as set forth in claim 19, wherein the credit count established according to the payment accepted by said entry-processing device is adjusted according to national currency exchange rate where the entry-processing device is installed.

22. A game system as set forth in claim 19, said central administrating device, wherein wagered credits are established correspondingly among third party players apart from those players executing the game, being further configured:
to establish via said terminal management devices wagered credits by crediting/deducting the credit counts the third parties own depending on the game result; and
according to the game result to credit/deduct by the wagered credits the credit counts the third parties own, and update the credit counts the third parties own with the calculated credit counts.

23. A game system as set forth in claim 19, wherein said central administrating device stores a game program, and the game system is set up to distribute the game program from said central administrating device to said game terminal devices.

24. A game system as set forth in claim 19, wherein games executed on the game system include educational information.

25. A player credit-wagering network game system enabling a plurality of players to conduct a game via the network, the network game system comprising:
a central administrating device;
a plurality of game terminal devices;
a plurality of terminal management devices linked-attached respectively to said plurality of game terminal devices;
at least one communications medium interconnecting said central administrating device and said plurality of game terminal devices;
player-portable recording mediums for recording credits used at least for executing games; and a credit issuing device connected to said central management device, and set up to be connectable with the portable recording mediums, for accepting payments from without said entry-processing device and writing into said portable recording mediums credit counts established. according to the payments;
said terminal management devices being configured
by connecting with the portable recording mediums, to carry out a game execution entry process, deduct from the credit counts stored on the portable recording mediums a predetermined credit count necessary for executing a game, update the credit counts stored on the portable recording mediums with the calculated credit counts, and enable execution of the game on said game terminal devices; and
said central administrating device being configured
via said terminal management devices to establish wagered credits wherein the credit counts stored on the portable recording mediums are credited/deducted depending on the game result, the wagered credits being established correspondingly among the players,
and in accordance with the game result credit/deduct by the wagered credits the credit counts the players own, and via said terminal management devices, update the players' owned credit count stored on the portable recording mediums with the calculated credit counts.

26. For a game system wherein a central administrating device, an entry-processing device, and a plurality of terminal management devices linked-attached respectively to a plurality of game terminal devices are interconnected via a communications medium, for enabling a plurality of players to conduct a game via the game terminal devices with the optional participation of spectator wagerers, a player credit-wagering network game method comprising:
(A) a step in the entry-processing device of accepting identification information on given players and spectator wagerers, and sending the given player and spectator wagerer identification information to the central administrating device;
(B) a step in the entry-processing device of accepting player and spectator wagerer payment from outside and sending information on the accepted payment to the central administrating device;
(C) a step in the terminal management devices of accepting identification information on the players and spectator wagerers, and sending the player and spectator wagerer identification information to the central administrating device;
(D) a step in the terminal management devices of receiving a game-executable signal from the central administrating device in response to said step (C) to enable execution of a game on the game terminal devices;
(E) a step in the central administrating device of establishing given player and spectator wagerer credit counts based on and in response to the accepted payment information received from the entry-processing device in said step (B);
(F) a step in the central administrating device of storing correlatively, as the credit count given players and spectator wagerers own, the established credit counts with the player and spectator wagerer identification information received from the entry-processing device in said step (B);
(G) a step in the central administrating device of deducting game-execution credits from the credit counts the given players own, and updating the credit counts the given players own with the deduction-calculated credit counts, when player identification information is received from terminal management devices in said step (C) and the credit counts the given players own meet a credit count predetermined to be needed for execution of a game on the game terminal devices;
(H) a step in the central administrating device of sending a game-executable signal to the terminal management devices on completing said step (G) wherein the credit counts given players own meet the credit count predetermined to be needed for execution of a game on the game terminal devices; and
(I) a step in the central administrating device of configuring via the terminal management devices game-outcome-dependent wagered credits correspondingly among all players and spectator wagerers participating in a game, and upon completion of the game, crediting/deducting depending on the game result the credit counts the given players and spectator wagerers own and updating the credit counts accordingly.
